(19) United States
(12) Patent Application Publication
(10) Pub. No.: US 2014/0192612 A1
(43) Pub. Date: Jul. 10, 2014

(54) Rotation and Revolution Magnetic Stirring Device for Producing Conductive Gold Balls

(71) Applicant: SHENZHEN FISHER INDUSTRIAL CO., LTD., Guangdong (CN)

(72) Inventors: Chang-Hou Zhao, Guangdong (CN); Ren-Liang Xiao, Guangdong (CN); Cheng-Gui Liu, Guangdong (CN); Chang-Wu Yang, Guangdong (CN); Xian-Fei Wan, Guangdong (CN); Hua-Guo Yin, Guangdong (CN); Jie Li, Guangdong (CN)

(21) Appl. No.: 14/128,630

(22) PCT Filed: Apr. 24, 2013
(86) PCT No.: PCT/CN2013/074635

§ 371 Date: Dec. 23, 2013

(30) Foreign Application Priority Data
May 15, 2012 (CN) 201210148750.4

(51) Int. Cl. B01F 13/08

(52) U.S. Cl. CPC B01F 13/08
USPC 366/200

(57) ABSTRACT

An autorotation and revolution magnetic stirring device for producing conductive golden particles comprises a mounting holder, a rotary electric motor, a flask, a magnetic stirrer, and a magnetic rotor. The rotary electric motor is fixed to the mounting holder. The flask is rotatably mounted to the mounting holder. The rotary electric motor provides rotary power to make the flask rotate. The magnetic rotor is put into the flask. The magnetic rotor rotates due to the magnetic force from the magnetic stirrer. In the present invention, the solvents in the flask rotate due to the rotary of the flask and the rotary of the magnetic rotor. “Revolution” and “autorotation” exist at the same time, so the solvents are stirred more adequately and more evenly so as to obtain an excellent surface treatment effect.

### CROSS-REFERENCE TO RELATED APPLICATION

This application is a continuation of International application No. PCT/CN2013/074635, filed on Apr. 24, 2013 which claims priority to Chinese Patent Application Serial No. 201210148750.4 filed on May 15, 2012.

### FIELD OF THE PRESENT INVENTION

The present invention relates to a kind of stirring device, which is used to make surface treatment for conductive golden particles or other particles to obtain an excellent surface treatment effect.

### BACKGROUND OF THE PRESENT INVENTION

When making surface treatment for particles for example polymer microspheres, especially during the course of producing conductive golden particles, chemical nickel plating or gold plated is indispensable. When using a single-function mechanical stirring device or magnetic stirring device, because the specific gravity of the particles is larger than the solvents which are used, a part of particles will sink to the bottom of the container which accommodates the particles and the solvents, so the particles and the solvents can not be stirred evenly. Therefore, a part of particles can not be treated evenly on their surfaces. That will make a part of particles become defective products. In order to obtain an even surface treatment effect, the problem that the particles sink down must be solved.

### SUMMARY OF THE PRESENT INVENTION

The technical problem that the present invention needs to overcome the defect that a traditional stirrer is used to obtain a bad mixing effect, then to provide an autorotation and revolution magnetic stirring device for producing conductive golden particles, which is used to make surface treatment for conductive golden particles so as to obtain an excellent mixing effect.

In order to solve the technical problem, the present invention puts forward the following technical solution: an autorotation and revolution magnetic stirring device for producing conductive golden particles comprises a mounting holder, a rotary electric motor, a flask, a magnetic stirrer, and a magnetic rotor. The rotary electric motor is fixed to the mounting holder. The flask is rotatably mounted to the mounting holder. The rotary electric motor provides rotary power to make the flask rotate. The magnetic rotor is put into the flask. The magnetic rotor rotates due to the magnetic force from the magnetic stirrer.

The further improvement of the technical solution is: the stirring device furtherly comprises a base, and the base comprises a bottom base and a column, and the column is perpendicular to the bottom base, and the mounting holder is rotatably mounted to the top end of the column.

The further improvement of the technical solution is: the magnetic stirrer is put on the bottom base.

The further improvement of the technical solution is: the stirring device furtherly comprises an angle adjusting knob, and the angle adjusting knob is fixed to the column.

The further improvement of the technical solution is; the stirring device furtherly comprises a water bath, and the water bath is put on the magnetic stirrer; and the lower part of the flask is dipped into the water bath.

The stirring device in accordance with the present invention has many advantages than prior arts. The autorotation and revolution magnetic stirring device for producing conductive golden particles in accordance with the present invention adds the magnetic stirrer and the magnetic rotor. When the rotary electric motor and the magnetic stirrer keep working, the particles and the solvents in the flask rotate due to the rotary of the flask and the rotary of the magnetic rotor. “Revolution” and “autorotation” exist at the same time, so the particles and the solvents are stirred more adequately and more evenly so as to obtain an excellent surface treatment effect.

### BRIEF DESCRIPTION OF THE DRAWINGS

FIG. 1 is a structure view of the autorotation and revolution magnetic stirring to device for producing conductive golden particles in accordance with the present invention.

### DESCRIPTION OF THE PREFERRED EMBODIMENT

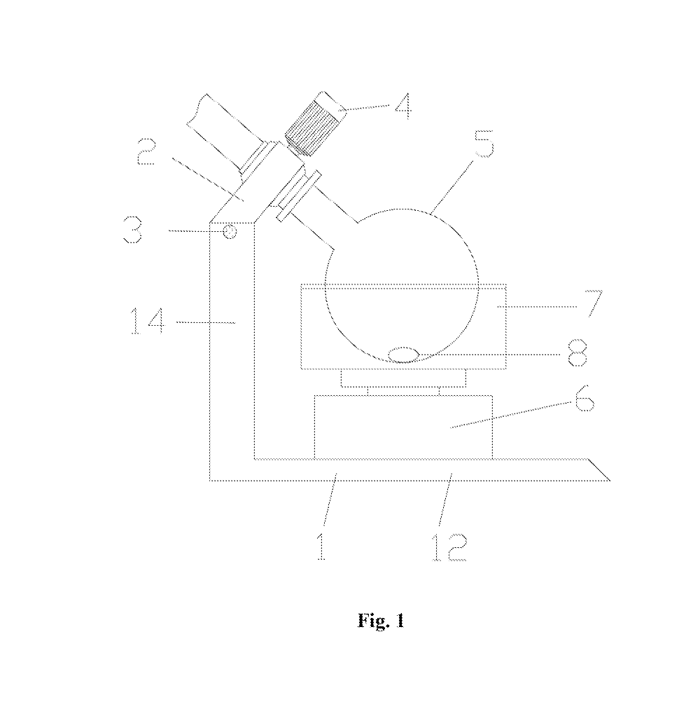

As shown in FIG. 1, the first embodiment of the autorotation and revolution magnetic stirring device for producing conductive golden particles in accordance with the present invention, comprises a base 1, a mounting holder 2, an angle adjusting knob 3, a rotary electric motor 4, a flask 5, a magnetic stirrer 6, a water bath 7, a magnetic rotor 8.

The base 1 comprises a bottom base 12 and a column 14. The column 14 is perpendicular to the bottom base 12.

The mounting holder 2 is rotatably mounted to the top end of the column 14. Only when the angle of the mounting holder 2 needs to be adjusted, the mounting holder 2 is rotated within 90 degrees.

The angle adjusting knob 3 is fixed to the column 14.

If rotating the angle adjusting knob 3, the angle between the mounting holder 2 and the column 14 will be adjusted.

The rotary electric motor 4 is fixed to the mounting bolder 2.

The neck of the flask 5 is rotatably mounted to the mounting holder 2.

At least two kinds of solvents which need to be mixed are put into the flask 5.

When the rotary electric motor 4 works, the rotary electric, motor 4 provides rotary power to make the flask 5 rotate. The particles and the solvents in the flask 5 also rotate, and this situation is called “revolution”.

The magnetic stirrer 6 is put on the bottom base 12.

The water bath 7 is put on the magnetic stirrer 6.

The lower part of the flask 5 is dipped into the water bath 7.

There is some water which is at one certain temperature in the water bath 7. The water is the heat source.

The magnetic rotor 8 is put into the flask 5.

When the magnetic stirrer 6 works, the magnetic rotor 8 rotates due to the magnetic force from the magnetic stirrer 6. During the course of rotary, the particles and the solvents also rotate, and this situation is called “autorotation”.

The autorotation and revolution magnetic stirring device for producing conductive golden particles in accordance with the present invention adds the magnetic, stirrer 6 and the magnetic rotor 8. When the rotary electric, motor 4 and the magnetic stirrer 6 keep working, the particles and the solvents in the flask 5 rotate due to the rotary of the flask 5 and the rotary of the magnetic rotor 8. “Revolution” and “autorotation” exist at the same time, so the particles and the solvents are stirred more adequately and more evenly so as to obtain an excellent surface treatment effect.

What is claimed is:

1. An autorotation and revolution magnetic stirring device for producing conductive golden particles, comprising:
a mounting holder;
a rotary electric motor, which being fixed to the mounting holder;
a flask, which being rotatably mounted to the mounting holder;
a magnetic stirrer;
a magnetic rotor;
said rotary electric motor providing rotary power to make the flask rotate;
said magnetic rotor being put into the flask;
said magnetic rotor rotating due to the magnetic force from the magnetic stirrer.

2. An autorotation and revolution magnetic stirring device for producing conductive, golden particles according to claim 1, wherein the stirring device furtherly comprises a base, and the base comprises a bottom base and a column, and the column is perpendicular to the bottom base, and the mounting holder is rotatably mounted to the top end of the column.

3. An autorotation and revolution magnetic stirring device for producing conductive golden particles according to claim 2, wherein the magnetic stirrer is put on the bottom base.

4. An autorotation and revolution magnetic stirring device for producing conductive golden particles according, to claim 2, wherein the stirring device furtherly comprises an angle adjusting knob, and the angle adjusting knob is fixed to the column.

5. An autorotation and revolution magnetic stirring device for producing conductive golden particles according to claim 1, wherein the stirring device furtherly comprises a water bath, and the water bath is put on the magnetic stirrer; and the lower part of the flask is dipped into the water bath.
